(19) United States
(12) Patent Application Publication
(10) Pub. No.: US 2004/0036442 A1
(43) Pub. Date: Feb. 26, 2004

(54) Battery charger for use indoors and in motor vehicle

(76) Inventor: Tony Wu, Kaohsiung City (TW)

Correspondence Address: Leong C. LEI, PMB #1008, 1867 Ygnacio Valley Road, WALNUT CREEK, CA, 94598-3214, US

(21) Appl. No.: 10/227,403

(22) Filed: Aug. 26, 2002

(51) Int. Cl. H02J 7/00

(52) U.S. Cl. 320/107

(57) ABSTRACT

A battery charger for indoor use and motor vehicle, primarily includes a battery charging board disposed on a base, and being covered by an upper casing to form a battery charger; an end of the charging board having a connector for connecting to the cigarette lighter socket in the car, and the other end of the charging board having an inserting plate for connecting to the indoor electric socket such that the battery charger of the present invention can be used for the battery charging indoors as well as in the car. In the meantime, the power cord can be stored by coiling; it does not only enhance the effect of use, but also provides a compact battery charger for convenient carrying.

### BACKGROUND OF THE INVENTION

(a) Field of the Invention

The present invention is related to a battery charger, and more particularly, to a battery charger that can be used indoors as well as in a motor vehicle.

(b) Description of the Prior Art

In the severe competition of the industrial society, mastering the time in order to capture the first opportunity becomes the one and only way to success. Therefore the mobile phone, which can make contact with others anytime, becomes a necessary tool. With the constructive research and development of the telecommunication industry, the size of the mobile phone is getting smaller and smaller for easy carrying. In the meantime, the battery idling time and telephone time is being extended. However, for those who have to travel a lot, they heavily rely on the timely battery charging. The battery charger is divided into two types according to its use: indoors and in the motor vehicle. The indoor battery charger 1, as shown in FIG. 1, has two parallel inserting plates 12 extended from a connector 11, and a power cord 13 being connected to the other end of the connector 11. The connector of the power cord has a connector 14 at its end and the shape of such connector 14 is different from different brand of mobile phones, such that the connector 14 is inserted into the mobile phone, and the inserting plates 12 being inserted into the indoor socket for battery charging. In FIG. 2, the car battery charger 2 has a power cord 22 at the rear end of a connector 21, and the power cord 22 has a connector 23 at its end so that the connector 23 can be inserted into the mobile phone, and the connection card of the connector is inserted into the cigarette lighter socket for battery charging in the car. The foregoing two battery charger structures definitely provide the battery charging for indoors use and the use in a car and also meet the requirements for the traveling and business trips. However, the two cannot be used interchangeably. The user has to bring both battery chargers with him/her for the need of battery charging. It is not convenient to carry both, and there is a need for improvement.

### SUMMARY OF THE INVENTION

The present invention is related to a battery charger, and more particularly, to a battery charger that can be used indoors as well as in a motor vehicle.

The primary purpose of the present invention is to provide a battery charger for indoor use as well as use in a car; by means of the connector for connecting to the cigarette lighter socket in the car and the indoor sockets, the battery charger can be used in two different occasion and thus enhance the use of battery charger.

The secondary purpose of the present invention is to provide a battery charger for indoor use and the use in a car; by means of coiling the power cord along the periphery, the connector at the end of the power cord can be hidden to reduce the overall volume for easy carrying.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a prior art indoor battery charger.

FIG. 2 shows a prior art battery charger in a car.

FIG. 3 is an exploded view of a preferred embodiment of the present invention.

FIG. 4 is a top perspective view of FIG. 3.

FIG. 5 is a bottom perspective view of FIG. 3.

FIG. 6 is a schematic diagram of the vertical insert plates and the closed accommodating groove of the present invention.

FIG. 7 shows the insert plate according to a preferred embodiment of the present invention.

FIG. 8 shows the insert plate of another preferred embodiment of the present invention.

FIG. 9 is a schematic view showing the storage of the power cord according to the present invention.

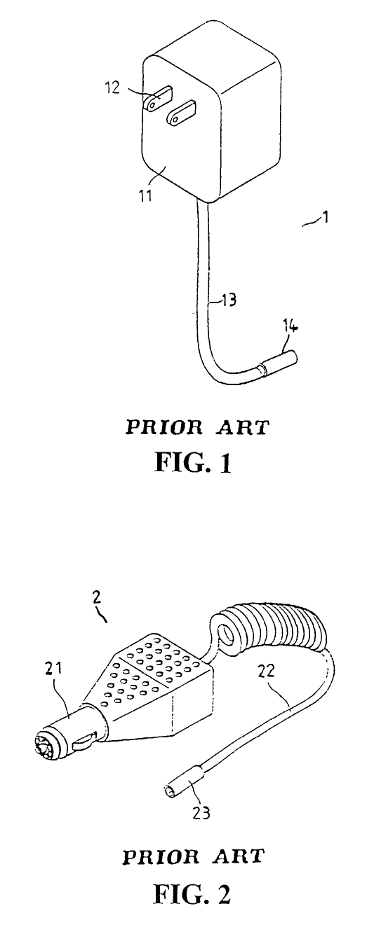

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

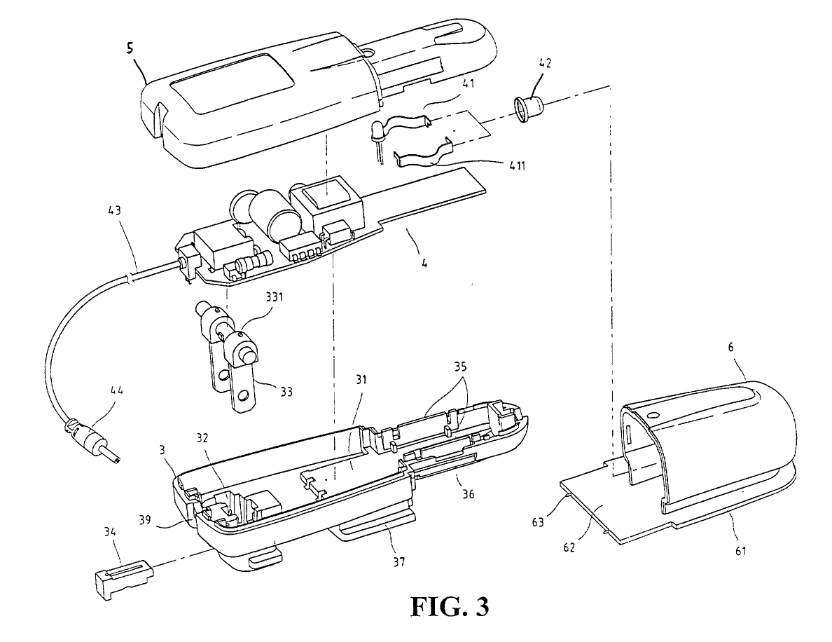

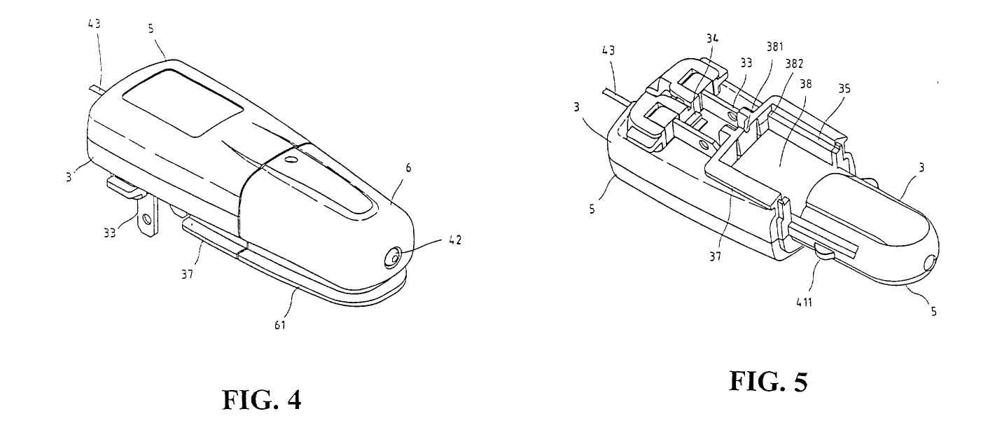

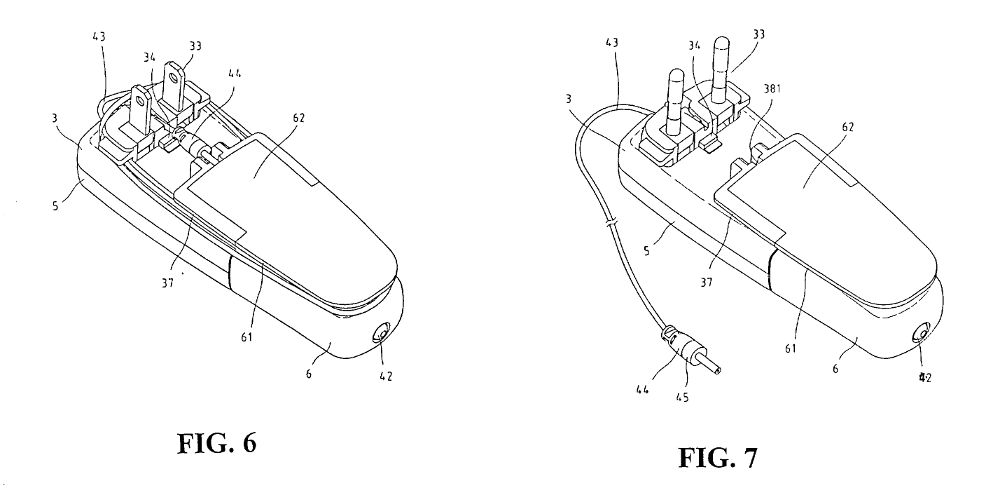

Referring to FIGS. 3 and 4. The battery charger of the present invention comprises a base 3, a charging board 4, an upper casing 5, and a cover 6; the top of the base 3 having a recession 31 for fixing the charging board 4 into position, and a passing groove hole 32 being disposed at the rear end of the recession 31 for holding two parallel insert plates 33, and a plug 34 being inserted to secure the insert plates 33 into position. In the meantime, the insert plates 33 can be folded freely as shown in FIG. 5 such that the insert plates can be attached to the bottom side of the base 3 for easy storage, or the insert plates could stand vertically as shown in FIG. 6 for inserting into the indoor socket. A guiding protrusion 331 is disposed on the bottom of the insert plate 33 such that when the insert plates are bent to the vertical position, the guiding protrusion 331 will be in contact with charging board 4 to give a conductive status, and parallel vertical plates 35 are disposed on both sides at the front of the base 3. A gap is left between the vertical plates 35 and the sidewall of the base 3, and an opening 36 of appropriate size is disposed on the sidewall. Please refer to FIGS. 5 and 6. An outwardly protruded wing board 37 is disposed on both sides of the bottom of the base 3 such that there is a gap between the outwardly protruded board of the wing board 37 and the bottom side of the base 3, and in the same time, a concave accommodating groove 38 is formed at the centers of the two wing boards 37. The groove 38 is formed with a recess 381 at the top of the inner wall and two cavities 382 at two sides of the recess 381.

The circuitry and electronic component for the battery charging are formed on the board charging board 4. Since these circuitry and components are prior arts and thus will not be described here. Two brackets 41 are disposed at the front side of the charging board 4, which are embedded into the gap between the vertical plates 35 at the front end of the base 3 and the sidewall, while the protruded end 411 of the two brackets 41 protrude outside the opening 36 to secure the two brackets in position, and the ends of the two brackets 41 press against a connector 42, and the head of the connector 42 protrudes from the corresponding end of the base 3 in order to correspond the negative node of the two brackets 41 to the positive node of the connector 42. It thus forms a connector that can adapt to the cigarette lighter socket in a car. A power cord 43 is set at the rear lateral side of the charging board 4, and such power cord 43 passes from the opening groove 39 at the center of the rear lateral side of the base, and in the meantime, a connector 44 is disposed at an end power cord 43. The shape of the connector 44 may differ according to different brands of mobile phones in order to adapt all kinds of mobile phones. The upper casing is a hollow body with the same appearance as the base 3, which can be coupled to the upper side of the case 3 such that the charging board 4 can be sealed between the base 3 and the upper casing 5. Screws can be used to fix the base 3 and the upper casing 5 more securely in practical implementation. As shown in FIG. 9, the connecting member for engaging with a mobile phone is not fixedly connected with the connector 44 of the power cord 43, so that it is only necessary for the manufacturer to prepare a number of connectors with different shapes in the groove 38 thereby enabling the present invention to adapt for use with different mobile phones. For the manufacturer, as the connecting member is not fixedly engaged with the connector 44, it will be unnecessary to fabricate a particular connector 44 for a certain mobile phone thus reducing the stock and therefore decreasing the capital required.

The cover 6 is a hollow body with an opening on the side for covering the front side of the battery charger, and two wing board 61 are formed on each side at the bottom of the cover for keeping an appropriate gap between the wing board 61 and the body and a shielding plate 62 extends between the wing boards 61. The shielding plate 62 is provided with two protuberances 63 at the outer edge aligned with the cavities 382 of the groove 38. Please refer to FIGS. 5 and 9. When the cover 6 is engaged with the head portion of the base 3, the top of the groove 8 is covered with the shielding plate 62 thereby closing the groove 38. In the meantime, the protuberances 63 are engaged with the cavities 382 to keep the shielding plate 62 firmly in place.

When the user wants to charge a battery in a car, the user just needs to plug the insert card of the connector 44 at the end of the power cord 43, and pull the cover 6 out to expose the connector 42 and the brackets 41 for the connection with the cigarette lighter socket and the process of charging battery. If the battery needs to be charged indoors, the insert plates 33 should be in the vertical position so that the insert plate can be inserted into the indoor socket for the battery charging. Therefore the battery charger of the present invention can use the insert plates at both ends of the brackets 41 of the connector 42 for charging battery indoors as well as in a car. It has the two-in-one function, and there is no need for the users to bring two battery chargers with then, which is very convenient in use.

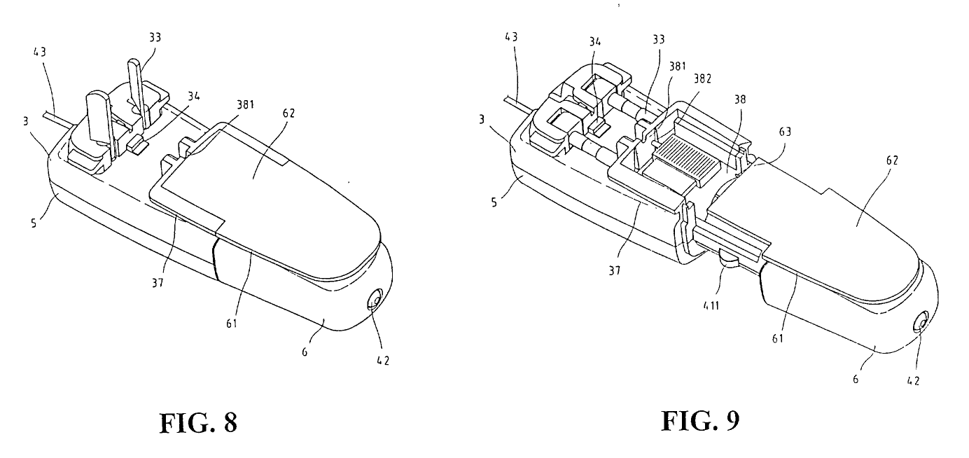

In addition, the insert plate 33 is a replaceable structure, and its shape can be changed according to different specifications in different countries. The insert plate could be in the shape of a rod as shown in FIG. 7, or a rotary V-shaped plate as shown in FIG. 8 to adapt the indoor sockets in different countries. Please refer to FIG. 6. When the battery charging is completed, the power cable 43 can be coiled around the battery charger since there is a gap reserved between the wing boards 37, 38, the base 3, and the cover 6. In the meantime, the connector 44 can be secured in the recess 381 of the accommodating groove 38, and the shielding plate 62 is pushed towards the bottom of the base 3 to keep the accommodating groove 38 in a closed condition such that the entire appearance of the battery charge is very neat and the power cord will not be tangled and swung freely.

It will be understood that each of the elements described above, or two or more together may also find a useful application in other types of methods differing from the type described above.

While certain novel features of this invention have been shown and described and are pointed out in the annexed claim it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A battery charger for use indoors and in a car, comprising:
a base, having a concave space on the top for accommodating and securing a charging board; a penetrating groove hole at the concave space for inserting two parallel insert plates, and a plug being used to secure the insert plates into position and in the meantime, the insert plate being freely bent, and vertical plates being disposed on both sides at front section of the base, a gap between the vertical plates and the sidewall of the base being kept, and an opening with appropriate size being set on the sidewall and a wing board being protruded outward from both sides of the bottom of the base such that a gap being kept between the protruded board of the wing board having and the bottom of the base, and a recessed accommodating groove being formed at the center of the two wing boards;
a charging board, having a charging circuitry and an electronic component for the battery charging on the board, two brackets being embedded into the gap between vertical plates in the front end of the base and the sidewall for securing the two brackets into position, while the protruded end of the two brackets pressing against a connector, of which the head of the connector protruding from the corresponsive end such that the two bracket together with the connector giving a connector for being inserted into the cigarette lighter socket in a car, and a power cord being disposed at the rear side of the charging board and such power cord passing from the opening at the center at the rear end of the power cable, and a connector being coupled at an end of the power cord;
an upper casing, being a hollow body with the same appearance of the base for integrating the upper side of the base such that the charging board being sealed between the base and the upper casing;
a cover, being a hollow body with an opening on a side for covering the front side end of the battery charger, and a wing board being protruded from each side of the cover, and a gap being kept between the wing board and the cover body, and a shielding plate being provided between two wing boards so that when the shielding plate being pushed and shifted towards the base, the accommodating groove is in a closed condition, or when the accommodating groove being pushed towards the cover, the accommodating groove is in an open condition.

2. A battery charger for use indoors and in a car as claimed in claim 1, wherein said connector on the base has a shape according to the change of different brands of mobile phones.

3. A battery charger for use indoors and in a car as claimed in claim 1, wherein said insert plate on the base has a shape according to the change of different brands of mobile phones.
